(19) United States
(12) Patent Application Publication
(10) Pub. No.: US 2023/0281472 A1
(43) Pub. Date: Sep. 7, 2023

(54) GENERATING TRAINING DATA SETS FOR POWER OUTPUT PREDICTION

(71) Applicant: STEM, INC., San Francisco, CA (US)

(72) Inventors: Babak ASGHARI, Vancouver (CA); Shyam SIVARAMAKRISHNAN, Fremont, CA (US); Mahadevan BALASUBRAMANIAN, Brentwood, CA (US)

(21) Appl. No.: 17/686,269

(22) Filed: Mar. 3, 2022

(51) Int. Cl. G06N 5/02; G06F 1/28

(52) U.S. Cl. CPC G06N 5/022; G06F 1/28

(57) ABSTRACT

Embodiments the present invention set forth techniques for generating training data sets for power output detection. In some embodiments, the techniques include receiving a set of data samples of features of at least one power generation device, determining, for each data sample, a distance between the features of the data sample and features of other data samples, identifying at least one outlier data sample of the data sample set, the identifying being based on the distance determined for each data sample, and generating a training data set for a machine learning model, wherein the training data set includes the set of data samples excluding at least one of the at least one outlier data sample.

### BACKGROUND

### Field of the Various Embodiments

Embodiments of the present disclosure relate generally to power generation devices, and, more specifically, to generating training data sets for power generation output prediction.

### Description of the Related Art

Advances in the field of machine learning and increases in computing power have led to machine learning models that are capable of predicting the output of power generation devices. For example, a photovoltaic device, such as a solar panel, can generate power for delivery to a power grid, storage in a storage device (e.g., a battery), or supply to another device (e.g., a factory machine). However, the power output of a power generation device, such as a photovoltaic device, can vary based on a variety of factors, such as solar irradiance, a cloud coverage, ambient temperature, humidity, geographic location, time of day, photovoltaic device type, or the like. The use of the collected power can be adjusted based on predicted features (e.g., weather forecasts) and corresponding predictions of the power output. As a first example, a factory machine can be scheduled to be online and operating during periods of high predicted power output, and can be scheduled to be offline for maintenance during periods of low predicted power output. As a second example, the factory machine can be scheduled and budgeted to operate on solar power during periods of high predicted power output, and can be scheduled and budgeted to operate on other power sources during periods of low predicted power output.

Predicting the maximum possible power output of a power generation device can be difficult due to the number and interrelationships of features that can affect power output. For example, some types of power generation devices can be more affected by ambient temperature than other types of power generation devices. In order to generate accurate predictions, machine learning models can be used to predict the power output of a particular power generation device based on a given set of features. Machine learning models are particularly useful for such predictions because the learning capabilities of the models can reflect the interrelationships between the complex set of features.

In order to generate a machine learning model with such capabilities, data samples can be collected from a set of power generation devices. Each data sample includes one or more features of the power generation device and the power output of the power generation device. For example, for a photovoltaic device, the features can include solar irradiance, cloud coverage, and ambient temperature, which can be collected from an on-site weather station or from a weather service provider for the location of an installed photovoltaic system. That is, the photovoltaic data samples can include photovoltaic device features, such as DC voltage of the photovoltaic panels; meteorological data; and the electric power output of the photovoltaic panels. Further, each data sample can be represented as a multi-dimensional vector. The data samples can be used as a training data set to train a machine learning model. After training, the trained machine learning model can be applied to a set of features of a particular power generation device in order to predict its power output.

One disadvantage with using machine learning models to predict power output is the difficulty of determining which data samples to use for the training data model. For example, the output of a power generation device can be affected by factors other than the aforementioned features, such as an equipment failure or an administrative decision to operate the power generation device below its maximum power output. In some cases, market regulations could require a system operator of a power generation facility to operate power generation devices below a maximum output. In some other cases, power interconnection regulations can require a power generation facility to limit the generation of power to the power consumed by the power generation facility and to refrain from exporting power to other facilities or a power grid. As a result of these and/or other considerations, some data samples can reflect an incorrect or inconsistent relationship between the particular features and a corresponding power output. In particular, as compared with a maximum achievable output of the power generation device in a maximum potential power generation mode, the measured power output of a power generation device could be reduced due to other factors. If the training data set includes unrepresentative data samples, the machine learning model trained on the training data set could underestimate or overestimate power output based on a given set of features. These inaccuracies can cause or contribute to inefficiency, such as scheduling a factory machine to operate based on an overestimated predicted power output and/or scheduling a factory machine to be offline based on an underestimated predicted power output.

As the foregoing illustrates, what is needed in the art are improved training data sets for power output prediction.

### SUMMARY

In some embodiments, a computer-implemented method includes receiving a set of data samples of features of at least one power generation device, determining, for at least some of the data samples, a distance between the features of the data sample and features of other data samples, identifying at least one outlier data sample of the data sample set, the identifying being based on the distances determined for the data samples, and generating a training data set for a machine learning model, wherein the training data set includes the set of data samples excluding at least one of the at least one outlier data sample.

In some embodiments, a system includes a memory that stores instructions, and a processor that is coupled to the memory and, when executing the instructions, is configured to receive a set of data samples of features of at least one power generation device, determine, for at least some of the data samples, a distance between the features of the data sample and features of other data samples, identify at least one outlier data sample of the data sample set, the identifying being based on the distances determined for the data samples, and generate a training data set for a machine learning model, wherein the training data set includes the set of data samples excluding at least one of the at least one outlier data sample.

In some embodiments, one or more non-transitory computer-readable media storing instructions that, when executed by one or more processors, cause the one or more processors to perform the steps of receiving a set of data samples of features of at least one power generation device, determining, for at least some of the data samples, a distance between the features of the data sample and features of other data samples, identifying at least one outlier data sample of the data sample set, the identifying being based on the distances determined for the data samples, and generating a training data set for a machine learning model, wherein the training data set includes the set of data samples excluding at least one of the at least one outlier data sample.

In some embodiments, a computer-implemented method includes receiving a set of data samples of features of a power generation device, and processing the set of data samples using a machine learning model to predict a power output of the power generation device, wherein the machine learning model has been trained on a set of data samples excluding at least one outlier data sample, and wherein the at least one outlier data sample has been determined based on a distance between features of the outlier data sample and features of other data samples of the set of data samples.

At least one technical advantage of the disclosed techniques is the improved accuracy of maximum possible power output predictions by machine learning models trained on the training data set. For example, based on a predicted power output and a measured power output of a power generation device, an alerting system can determine whether the power generation device is operating in a maximum potential power generation (MPPG) mode. Due to the improved accuracy, power output predictions can be relied upon with greater confidence for resource planning and scheduling. Further, machine learning models can be more rapidly and successfully trained using the training data set due to improved consistency of the included data samples. Thus, training machine learning models based on the training data set can be accomplished with greater efficiently and reduced time and energy expenditure. Also, due to the improved speed and likelihood of success of training, the machine learning models can be retrained and deployed on an updated training data set more quickly, thus improving the adaptability of the machine learning models to new data. Also, the training data set can include a larger variety of data points that are collected from a wider variety of power generation devices and/or under a wider variety of circumstances. As a result, machine learning models that are trained on the training data set have a wider range of robustness in terms of the combinations of features for which predictions can be accurately generated. Finally, excluding outliers from the training data set can avoid a problem in which a machine learning model trained with non-MPPG data points could underestimate the achievable power output of other power generation devices, resulting in the collection of additional non-MPPG data points that diminish future predictions. Identifying and excluding the non-MPPG data points from this vicious cycle can therefore improve the cycle of accurate predictions and the operation of power generation devices in an MPPG mode based on the predictions. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a system configured to implement one or more embodiments;

FIG. 2 is an illustration of training the machine learning model of FIG. 1, according to one or more embodiments;

FIG. 3 is an illustration of predicting a power output of a power generation device by the machine learning model of FIGS. 1-2, according to one or more embodiments;

FIG. 4 is a flow diagram of method steps for predicting a power output of a power generation device by the machine learning model of FIGS. 1-3, according to one or more embodiments; and

FIG. 5 is another flow diagram of method steps for predicting a power output of a power generation device by the machine learning model of FIGS. 1-3, according to one or more embodiments.

### DETAILED DESCRIPTION

In the following description, numerous specific details are set forth to provide a more thorough understanding of the various embodiments. However, it will be apparent to one of skilled in the art that the inventive concepts may be practiced without one or more of these specific details.

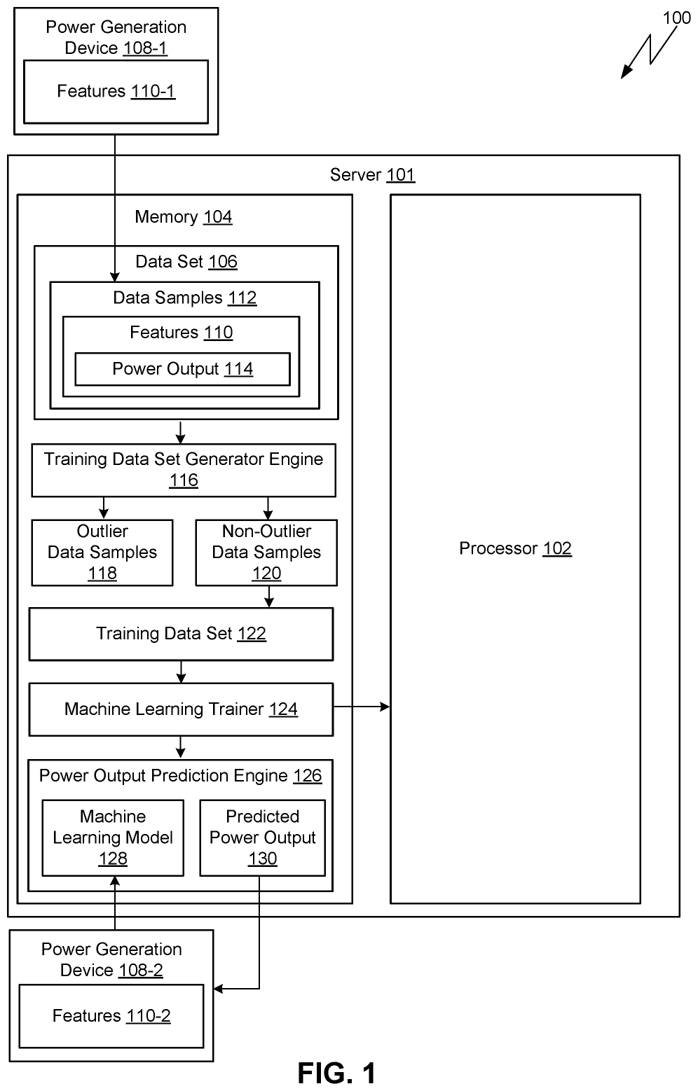

FIG. 1 is a system 100 configured to implement one or more embodiments. As shown, a server 101 within system 100 includes a processor 102 and a memory 104. The memory 104 includes a data set 106, a training data set generator engine 116, a training data set 122, a machine learning trainer 124, and a power output prediction engine 126. The power output prediction engine 126 includes a machine learning model 128.

As shown, the system 100 receives a set of features 110-1 of a power generation device 108-1. As an example, for a photovoltaic device, the features 110-1 can include solar irradiance, cloud coverage, ambient temperature, geographic location, humidity, time of day, photovoltaic device type, a power output 114 of the photovoltaic device 108-1, or the like. The set of features 110-1 can be based on data received from the power generation device 108-1 and/or from another source, such as an on-site weather station or from a weather service provider for the location of an installed photovoltaic system. The system 100 receives the set of features 110-1 from the power generation device set 108-1 and generates a data set 106. The data set 106 can include a set of data samples 112, each associating some features 110 of the power generation device 108-1 with a power output 114. The system 100 can store the features 110 of a set of power generation devices in the data set 106.

As shown, the training data set generator engine 116 is a program stored in the memory 104 and executed by the processor 102 to generate a training data set 122 based on the data set 106 of collected features 110-1. In particular, the training data set generator engine 116 identifies at least some of the data samples 112 of the data set 106 as either an outlier data sample 118 or a non-outlier data sample 120. The training data set generator engine 116 generates the training data set 122 that includes at least one of the non-outlier data samples 120 and excludes at least one of the outlier data samples 118.

The training data set generator engine 116 classifies at least some of the data samples 112 as either an outlier data sample 118 or a non-outlier data sample 120. In some embodiments, the non-outlier data samples 120 are data samples 112 collected from power generation devices 108 that are operating in an MPPG mode, and the outlier data samples 118 are data samples 112 collected from power generation devices 118 that are operating in a non-MPPG mode. In some embodiments, the non-outlier data samples 120 are data samples 112 for which the power output 114 is consistent with the other features 110 of the data sample 112, and the outlier data samples 118 are data samples 112 for which the power output 114 is not consistent with the other features 110 of the data sample 112. In some embodiments, the non-outlier data samples 120 are data samples 112 that have a similar relationship between the features 110 and the power output 114 as other data samples 112 of the data set 106, and the outlier data samples 118 are data samples 112 that do not have a similar relationship between the features 110 and the power output 114 as other data samples 112 of the data set 106. In some embodiments, the data samples 112 are collected from a single power generation device 108 that is sometimes operating in an MPPG mode and sometimes operating in a non-MPPG mode, the machine learning model 128 is trained on only the MPPG-mode data samples. The predictions of the machine learning model 128 can be used to determine whether the single power generation device 108 is currently operating in an MPPG mode or a non-MPPG mode.

In particular, the training data set generator engine 116 classifies the data samples 112 as outlier data samples 118 or non-outlier data samples 120 based on distances between the features 110 of one data sample 112, including power output 114, and the features 110 of the other data samples 112, including power output 114. For example, the data set 106 can represent the data samples 112 within a feature space, where each axis of the feature space represents a type of feature 110, such as solar irradiance, ambient temperature, power output 114, or the like. The training data set generator engine 116 determines a distance within the feature space between the features 110 of a data sample 112 and the features 110 of other data samples 112 of the data set 106. In some embodiments, the training data set generator engine 116 performs a K-nearest-neighbor determination between the features of one data sample and the features of the other data samples 112. For example, the training data set generator engine 116 can determine the distance based on a subset of nearest data samples 112 within the feature space, such as a subset of the K nearest data samples 112 within the feature space.

In some embodiments, the training data set generator engine 116 classifies the data samples 112 as outlier data samples 118 or non-outlier data samples 120 based on one or more rules. For example, the training data set generator engine 116 could store compare a solar generation measurement of a photovoltaic device with a nameplate capacity of an AC/DC inverter of the photovoltaic device. If the solar generation measurement matches the nameplate capacity, the training data set generator engine 116 could determine that the power output of the photovoltaic device is being limited to a non-MPPG mode, and that data samples 112 collected from the photovoltaic device are outlier data samples 118. In some embodiments, the training data set generator engine 116 applies one or more rules to classify the data samples 112 in addition to (e.g., before) other techniques, such as applying a K-nearest-neighbor determination to the remaining data samples 112.

Based on the determined distances, the training data set generator engine 116 identifies outlier data samples 118 among the data samples 112 of the data set 106. In some embodiments, the training data set generator engine 116 identifies the data samples 112 based on a comparison of a power output feature of the data sample and a power output measurement during a maximum potential power generation (MPPG) mode of a power generation device associated with the data sample 112. For example, the training data set generator engine 116 can evaluate at least some of the data samples 112 in order to determine whether the data sample 112 is an outlier data sample 118 (e.g., a data sample 112 having a larger aggregate distance than some of the other data samples 112) or a non-outlier data sample 120 (e.g., a data sample 112 having a smaller aggregate distance than some of the other data samples 112). In some embodiments, the training data set generator engine 116 determines and applies weights to the respective features 110 in order to adjust the identification of outlier data samples 118 of the data set 106. In some embodiments, the training data set generator engine 116 applies a large weight to the distance between power outputs 114 of power generation devices 108. Applying a large weight to the distances of the power outputs 114 applied can highlight the operation of a particular power generation device 108 below the maximum potential power generation (MPPG) mode of the power generation device 108.

The training data set generator engine 116 generates a training data set 122 that includes the non-outlier data samples 120 and excludes at least one of the outlier data samples 118. That is, while the power output 114 is included in the set of features 110 used to determine the distances between the data samples 112, the training data set 122 associates some of the features 110 of each data sample 112 with a power output 114 of the data sample 112. In some embodiments in which the training data set generator engine 116 applies a weight to the distances between power outputs 114, the outlier data samples 118 include data samples 112 that are collected from power generation devices 108 operating in a non-MPPG mode, and the non-outlier data samples 118 include data samples 112 that are collected from power generation devices 108 operating in an MPPG mode.

The machine learning model 128 generates a predicted power output 130 of a power generation device 108 based on a set of features 110 of the power generation device 108. The machine learning model 128 can be, for example, an artificial neural network including a series of layers of neurons. Each neuron multiples an input by a weight, processes a sum of the weighted inputs using an activation function, and provides an output of the activation function as the output of the artificial neural network and/or as input to a next layer of the artificial neural network.

As shown, the machine learning trainer 124 is a program stored in the memory 104 and executed by the processor 102 to train the machine learning model 128 using the training data set 122 to predict power outputs 114 of power generation devices 108 based on a set of features 110. For at least some of the data samples 112 of the training data set 122, the machine learning trainer 118 predicts a power output 114 based on other features 110 of the data sample 112. If the power output 114 stored in the training data set 122 and the predicted power output 130 do not match, then the machine learning trainer 124 adjusts the parameters of the machine learning model 128 to reduce the difference. The machine learning trainer 124 trains the machine learning model 128 until the performance metric indicates that the correspondence of the power outputs 114 of the training data set 122 and the predicted power outputs 130 is within an acceptable range of accuracy.

As shown, the power output prediction engine 126 is a program stored in the memory 104 and executed by the processor 102 to generate, by the machine learning model 128, a predicted power output 130 of a power generation device 108 based on other power features 110 of the power generation device 108. For example, the power output prediction engine 126 receives a set of features 110-2 for a power generation device 108-2, wherein the set of features 110-2 does not include the power output 114. The power output prediction engine 126 provides the set of features 110-2 as input to the machine learning model 128. The power output prediction engine 126 receives the output of the machine learning model 128 as the predicted power output 130 of the power generation device 108-2. In some embodiments, the power output prediction engine 126 translates an output of the machine learning model 128 into the predicted power output 130, e.g., by scaling the output of the machine learning model 128 and/or adding an offset to the output of the machine learning model 128.

Some embodiments of the disclosed techniques include different architectures than as shown in FIG. 1. As a first such example and without limitation, various embodiments include various types of processors 102. In various embodiments, the processor 102 includes a CPU, a GPU, a TPU, an ASIC, or the like. Some embodiments include two or more processors 102 of a same or similar type (e.g., two or more CPUs of the same or similar types). Alternatively or additionally, some embodiments include processors 102 of different types (e.g., two CPUs of different types; one or more CPUs and one or more GPUs or TPUs; or one or more CPUs and one or more FPGAs). In some embodiments, two or more processors 102 perform a part of the disclosed techniques in tandem (e.g., each CPU training the machine learning model 128 over a subset of the training data set 122). Alternatively or additionally, in some embodiments, two or more processors 102 perform different parts of the disclosed techniques (e.g., a first CPU that executes the machine learning trainer 124 to train the machine learning model 128, and a second CPU that executes the power output prediction engine 126 to determine the predicted power outputs 130 of power generation devices 108 using the trained machine learning model 128).

As a second such example and without limitation, various embodiments include various types of memory 104. Some embodiments include two or more memories 104 of a same or similar type (e.g., a Redundant Array of Disks (RAID) array). Alternatively or additionally, some embodiments include two or more memories 104 of different types (e.g., one or more hard disk drives and one or more solid-state storage devices). In some embodiments, two or more memories 104 store a component in a distributed manner (e.g., storing the training data set 122 in a manner that spans two or more memories 104). Alternatively or additionally, in some embodiments, a first memory 104 stores a first component (e.g., the training data set 122) and a second memory 104 stores a second component (e.g., the machine learning trainer 124).

As a third such example and without limitation, some disclosed embodiments include different implementations of the machine learning trainer 124 and/or the power output prediction engine 126. In some embodiments, at least part of the machine learning trainer 124 and/or the power output prediction engine 126 is embodied as a program in a high-level programming language (e.g., C, Java, or Python), including a compiled product thereof. Alternatively or additionally, in some embodiments, at least part of the machine learning trainer 124 and/or the power output prediction engine 126 is embodied in hardware-level instructions (e.g., a firmware that the processor 102 loads and executes). Alternatively or additionally, in some embodiments, at least part of the machine learning trainer 124 and/or the power output prediction engine 126 is a configuration of a hardware circuit (e.g., configurations of the lookup tables within the logic blocks of one or more FPGAs). In some embodiments, the memory 104 includes additional components (e.g., machine learning libraries used by the machine learning trainer 124 and/or the power output prediction engine 126).

As a fourth such example and without limitation, instead of one server 101, some disclosed embodiments include two or more servers 101 that together apply the disclosed techniques. Some embodiments include two or more servers 101 that perform one operation in a distributed manner (e.g., a first server 101 and a second server 101 that respectively train the machine learning model 128 over different parts of the training data set 122). Alternatively or additionally, some embodiments include two or more servers 101 that execute different parts of one operation (e.g., a first server 101 that processes the machine learning model 128, and a second server 101 that translates an output of the machine learning model 128 into a predicted power output 130). Alternatively or additionally, some embodiments include two or more servers 101 that perform different operations (e.g., a first server 101 that trains the machine learning model 128, and a second server 101 that executes the power output prediction engine 126). In some embodiments, two or more servers 101 communicate through a localized connection, such as through a shared bus or a local area network. Alternatively or additionally, in some embodiments, two or more servers 101 communicate through a remote connection, such as the Internet, a virtual private network (VPN), or a public or private cloud.

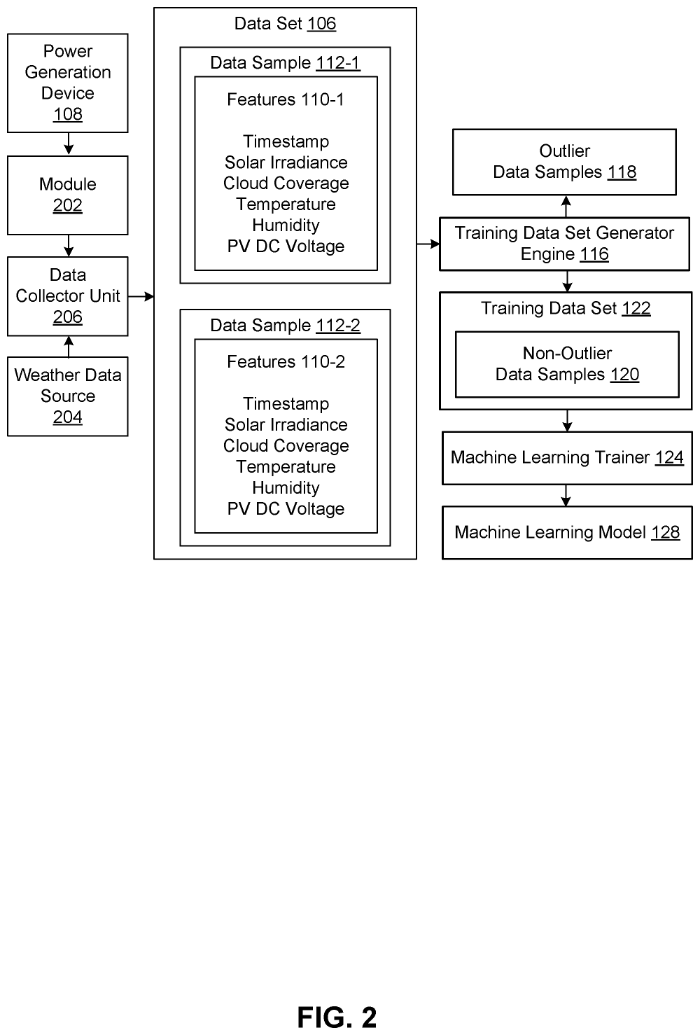

FIG. 2 is an illustration of training a machine learning model using the training data set of FIG. 1, according to one or more embodiments. The training can be, for example, an operation of the machine learning trainer 124 of FIG. 1.

As shown, one or more modules 202 transmit data from one or more power generation devices 108 to a data collector unit 206. As shown, the power generation device 108 is a photovoltaic device and the collected data includes photovoltaic data. However, the concepts illustrated in FIG. 2 could be applied to other types of power generation devices 108 and features, such as wind power generation devices, hydroelectric power generation devices, geothermal power generation devices, or the like.

One or more weather data sources 204 transmit data about weather conditions to the data collector unit 206. The data collector unit 206 generates a data set 106 of data samples 112-1, 112-2, each data sample 112 including a set of features 110-1, 110-2 for one of the power generation devices 108. For example, the features 110 for each data sample 112 can include a solar irradiance feature (e.g., a measurement of irradiance of the power generation device 108-1). The sets of features 110-1, 110-2 can include a weather feature (e.g., humidity, precipitation, or the like, as measured during a time of a data sample collection). The sets of features 110-1, 110-2 can include a cloud coverage feature (e.g., an ultraviolet index indicating a measurement of cloudiness during a time of a data sample collection). The sets of features 110-1, 110-2 can include an ambient temperature feature. The sets of features 110-1, 110-2 can include a geographic location feature (e.g., a latitude, longitude, and/or elevation of the first power generation device 108-1). The sets of features 110-1, 110-2 can include a power generation device type feature (e.g., an equipment type of the first power generation device 108-1). The sets of features 110-1, 110-2 can include a data sample time feature (e.g., a time of day of a data sample collection). The sets of features 110-1, 110-2 can include a power output feature (e.g., a power output generated by the first power generation device 108-1 during a period of a data sample collection). The sets of features 110-1, 110-2 can include one or more fixed or static features, such as a fixed location of the power generation device 108-1. The sets of features 110-1, 110-2 can include one or more dynamic features, and can include an indication of a date and/or time of recording such a feature, such as a timestamp. In some embodiments, the data collector unit 206 stores each of the data samples 112 as a multidimensional vector.

The data sample set 106 includes the features 110-1 received from the data collector unit 206 from one or more power generation devices 108. The data set 106 can include a set of data samples 112, each associating some features 110 of each power generation device 108 with a power output 114. The power output can be, for example, a measurement of output voltage, output current, output power, energy storage, or the like. The one or more other power generation device 108 can be of a same or similar types, or of different types. In some embodiments, the data set 106 includes an identifier of the particular power generation device 108 that provided each data sample 112.

The training data set generator engine 116 identifies at least some data samples 112 of the data set 106 as either an outlier data sample 118 or a non-outlier data sample 120. The training data set generator engine 116 includes the non-outlier data samples 120 of the data set 106 in the training data set 122 and excludes at least one of the outlier data samples 118 of the data set 106 from the training data set 122. In particular, the training data set generator engine 116 distinguishes between outlier data samples 118 and non-outlier data samples 120 based on determinations of distances between the features 110 of one data sample 112 and the features 110 of the other data samples 112. For example, the data set 106 represents the data samples 112 within a feature space, where each axis of the feature space represents a type of feature 110, such as solar irradiance, ambient temperature, power output, or the like. In some embodiments, the training data set generator engine 116 normalizes each numerical feature 110 of at least some of the data samples 112, such as by scaling and offsetting each numerical feature 110 to fit a statistical range. The training data set generator engine 116 determines a distance within the feature space between the features 110 of a data sample 112 and the features 110 of other data samples 112 of the data set 106. The distance can be calculated, for example, as a Minkowski distance such as a Manhattan distance or a Euclidean distance, a Mahalanobis distance, a cosine similarity, or the like. For a particular data sample 112, the training data set generator engine 116 can determine the distance with regard to the other data samples 112 based on an aggregation of individual distance determinations with regard to individual other data samples 112, such as an arithmetic mean or arithmetic median of the individual distance determinations.

In some embodiments, the training data set generator engine 116 includes a machine learning model that learns to identify outlier data samples 118 among the data samples 112 of the data set 106. For example, in some embodiments, the training data set generator engine 116 identifies the outlier data samples based on a K-nearest-neighbor determination. For example, the training data set generator engine 116 can determine the distance based on a subset of nearest data samples 112 within the feature space, such as a subset of the K nearest data samples 112 within the feature space. In some embodiments, the training data set generator engine 116 selects, from the features 110, a subset of features 110 for the training data set 122. For example, the training data set generator engine 116 can evaluate the feature space to determine independence and/or correlations among the features 110 and remove features 110 that are redundant with other features 110. Removing some of the features can reduce the complexity of the feature space.

Based on the determined distances, the training data set generator engine 116 identifies outlier data samples 118 among the data samples 112 of the data set 106. For example, the training data set generator engine 116 can evaluate at least some of the data samples 112 in order to determine whether the data sample 112 is an outlier data sample 118 (e.g., a data sample 112 having a larger aggregate distance than some of the other data samples 112) or a non-outlier data sample 120 (e.g., a data sample 112 having a smaller aggregate distance than some of the other data samples 112). In some embodiments, the training data set generator engine 116 identifies the outlier data samples 118 as the data samples 112 having a determined distance that is above a threshold distance. For example, the training data set generator engine 116 can identify the outlier data samples 118 as the data samples 112 having aggregate distance above a threshold distance, and can identify the non-outlier data samples 120 as the data samples 112 having a distance below the threshold distance. In some embodiments, the training data set generator engine 116 identifies the data samples 112 based on a ranking of the data samples 112. In some embodiments, the training data set generator engine 116 ranks the data samples 112 by the determined distances and identifies, as the outlier data samples 118, the data samples 112 that are within a top portion of the ranking. In some embodiments, the training data set generator engine 116 identifies the outlier data samples 118 as the data samples 112 within an upper fixed number or percentile of the largest distances of the data samples 112, and identifies the non-outlier data samples 120 as the data samples 112 that are not within the upper fixed number or percentile of the largest distances of the data samples 112. In some embodiments, the training data set generator engine 116 adjusts the selection of the non-outlier data samples 120 in order to improve the balance of the training data set 122, such as selecting a comparable number of non-outlier data samples 120 for each of two or more clusters of data samples that occur within the feature space.

In some embodiments, the training data set generator engine 116 determines and applies weights to the respective features 110 in order to adjust the identification of outlier data samples 118 of the data set 106. In some embodiments, the training data set generator engine 116 selects the weights based on determinations such as a distribution of at least some of the features 110 among the data samples 112. For example, the training data set generator engine 116 can apply a larger weight to the distances of one data feature, such as ambient temperatures, than to the distances of other features 110, such as humidity. The training data set generator engine 116 can determine the relative weights based on various factors, such as a variance of the feature 110 among the data samples 112 and/or a correlation of the feature 110 with other features 110, such as power output 114. In particular, the training data set generator engine 116 can apply a large weight to the distance between power outputs 114 of power generation devices 108. Applying a large weight to the distances of the power outputs 114 applied can highlight the operation of a particular power generation device 108 below the maximum potential power generation (MPPG) mode of the power generation device 108. For example, the set of power generation devices 108 with similar features 110 can include several power generation devices 108 that are operating in an MPPG mode and a one power generation device 108 that is operating outside of an MPPG mode. The power output 114 of the one power generation device 108 is below the power outputs 114 of the other power generation devices 108. The system applies a large weight to the distance determinations of the power outputs 114 of the data samples 112. As a result, the distance between the power output 114 of the one power generation device 108 and the power outputs 114 of other power generation devices 108 is large. That is, the training data set generator engine 116 applies a large weight to the distances between power outputs 114 in order to improve the identification, as outlier data samples 118, of data samples 112 that are collected from power generation devices 108 operating in a non-MPPG mode.

The training data set generator engine 116 generates a training data set 122 that includes the non-outlier data samples 120 and excludes at least one of the outlier data samples 118. In some embodiments, the training data set generator engine 116 further generates a training data set 122 that includes one or more batches of non-outlier data samples 120. In some embodiments, the training data set generator engine 116 further generates a training data set 122 that includes one or more subsets of non-outlier data samples 120 for training the machine learning model 128, one or more subsets of non-outlier data samples 120 for validating the structure of the machine learning model 128, and/or one or more subsets of non-outlier data samples 120 for testing the machine learning model 128 after training. In some embodiments, the training data set 122 includes non-outlier data samples 120 of power generation devices operating in an MPPG mode, and excludes at least one of the outlier data samples 118 of power generation devices 108 operating in a non-MPPG mode.

The machine learning model 128 generates a predicted power output 130 of a power generation device 108 based on a set of features 110 of the power generation device 108. The machine learning model 128 can be, for example, an artificial neural network including a series of layers of neurons. In various embodiments, the neurons of each layer are at least partly connected to, and receive input from, an input source and/or one or more neurons of a previous layer. Each neuron can multiply each input by a weight; process a sum of the weighted inputs using an activation function; and provide an output of the activation function as the output of the artificial neural network and/or as input to a next layer of the artificial neural network. In some embodiments, the machine learning model 128 includes one or more convolutional neural networks (CNNs) including a sequence of one or more convolutional layers. The first convolutional layer evaluates the features 110 of a data sample 112 of the training data set 122 using one or more convolutional filters to determine a first feature map. A second convolutional layer in the sequence receives the first feature map for each of the one or more filters as input and further evaluates the first feature map using one or more convolutional filters to generate a second feature map. A third convolutional layer in the sequence receives the second feature map as input and generates a third feature map, etc. The machine learning model 128 can evaluate the feature map produced by the last convolutional layer in the sequence (e.g., using one or more fully-connected layers) to generate an output.

Alternatively or additionally, in various embodiments, the machine learning model 128 can include memory structures, such as long short-term memory (LSTM) units or gated recurrent units (GRU); one or more encoder and/or decoder layers; or the like. Alternatively or additionally, the machine learning model 128 can include one or more other types of models, such as, without limitation, a Bayesian classifier, a Gaussian mixture model, a k-means clustering model, a decision tree or a set of decision trees such as a random forest, a restricted Boltzmann machine, or the like, or an ensemble of two or more machine learning models of the same or different types. In some embodiments, the power output prediction engine 126 includes two or more machine learning models 128 of a same or similar type (e.g., two or more convolutional neural networks) or of different types (e.g., a convolutional neural network and a Gaussian mixture model classifier) that the power output prediction engine 126 uses together as an ensemble.

The machine learning trainer 124 trains the machine learning model 128 using the training data set 122 to predict power outputs 114 of power generation devices 108 based on a set of features 110. In various embodiments, the machine learning trainer 124 can use a variety of hyperparameters for choosing the neuron architecture of the machine learning model 128 and/or the training regimen. The hyperparameters can include, for example (without limitation), a machine learning model type, a machine learning model parameter such as a number of neurons or neuron layers, an activation function used by one or more neurons, and/or a loss function to evaluate the performance of the machine learning model 128 during training. The machine learning trainer 124 can select the hyperparameters through various techniques, such as a hyperparameter search process or a recipe.

In some embodiments, for at least some of the data samples 112 of the training data set 122, the machine learning trainer 118 predicts a power output 114 of a data sample 112 based on other features 110 of the data sample 112. If the power output 114 stored in the training data set 122 and the predicted power output 130 do not match, then the machine learning trainer 124 adjusts the parameters of the machine learning model 128 to reduce the difference. The machine learning trainer 124 can repeat this parameter adjustment process over the course of training until the predicted power outputs 130 are sufficiently close to or match the power outputs 114 stored in the training data set 122. In various embodiments, during training, the machine learning trainer 124 monitors a performance metric, such as a loss function that indicates the correspondence between the power outputs 114 stored in the training data set 122 and the predicted power outputs 130 for at least some of the data samples 112 of the training data set 122. The machine learning trainer 124 trains the machine learning model 128 through one or more epochs until the performance metric indicates that the correspondence of the power outputs 114 of the training data set 122 and the predicted power outputs 130 is within an acceptable range of accuracy (e.g., until the loss function is below a loss function threshold).

In some embodiments, the machine learning trainer 124 retrains the machine learning model 128 based on an update of the training data set 122. In various embodiments, the machine learning trainer 124 retrains the machine learning model 128 periodically (e.g., once per week), in response to a change of the power generation device 108 (e.g., when a power generation device array is reconfigured), and/or in response to an update of the data set 106 (e.g., receiving new data samples 112). For example, an update of the training data set 122 can include new data samples 112 about new power generation devices 108, e.g., new power generation device types. An update of the training data set 122 can include new data samples 112 from the same power generation device 108 for which the machine learning model 128 is trained to predict power output 130. An update of the training data set 122 can include supplemental data samples 112 indicating the power output 114 of power generation devices 108 based on new sets of features 110, e.g., new or previously underrepresented weather conditions. Alternatively or additionally, in some embodiments, the machine learning trainer 124 retrains the machine learning model 128 based on additional machine learning model optimization and/or training techniques. For example, in some embodiments, the power output prediction engine 126 performs a hyperparameter search process during a retraining to determine whether updating at least one hyperparameter of the architecture and/or training of the machine learning model 128 improves the performance of the machine learning model 128. If so, the machine learning trainer 124 performs the retraining using one or more updated hyperparameters. In some embodiments, the machine learning trainer 124 classifies new and/or existing data samples 112 of the data set 106 as outlier data samples 118 and/or non-outlier data samples 120 during the retraining. For example, an update of the training data set 122 can include corrected data samples 112 to replace previously incorrect data samples 112, and/or can exclude some previously included data samples 112 that the training data set generator engine 116 has more recently identified as outlier data samples 118. Based on the update of the training data set 122, the machine learning trainer 124 can retrain or resume training of the machine learning model 128, and/or can replace the machine learning model 128 with a newly trained replacement machine learning model 128.

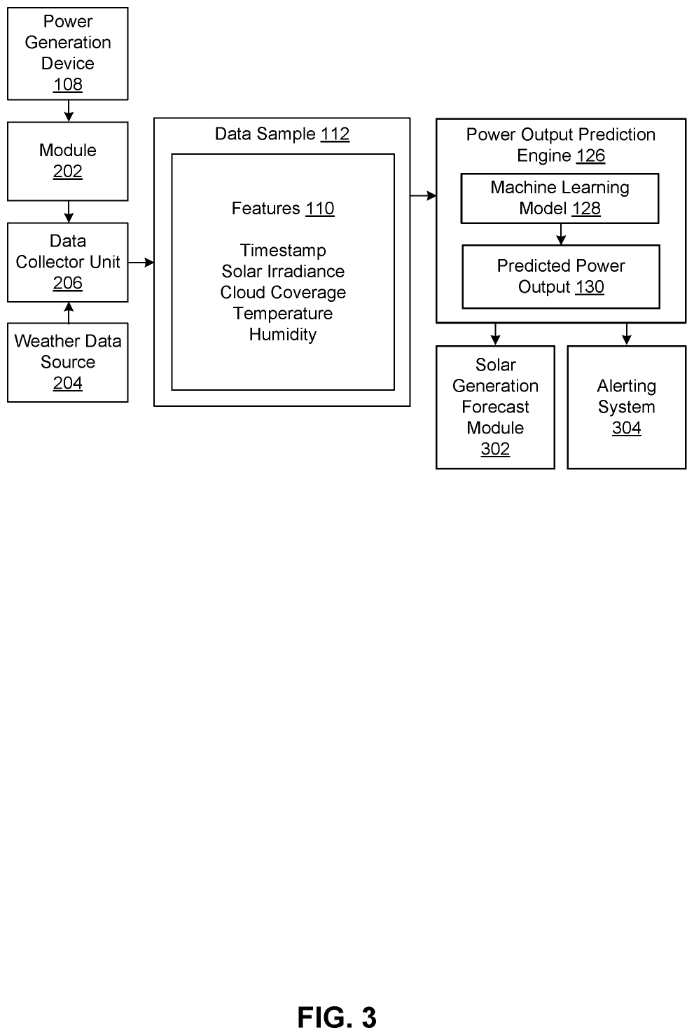

FIG. 3 is an illustration of predicting a power output of a power generation device by the machine learning model of FIGS. 1-2, according to one or more embodiments. The predicting can be, for example, an operation of the power output prediction engine 126 of FIG. 1.

As shown, one or more power modules 202 transmit data from a power generation device 108 to a data collector unit 206. As shown, the power generation device 108 is a photovoltaic device and the collected data includes photovoltaic data. However, the concepts illustrated in FIG. 3 could be applied to other types of power generation devices 108 and features, such as wind power devices, hydroelectric power devices, geothermal power devices, or the like.

One or more weather data sources 204 transmit data about weather conditions to the data collector unit 206. In some embodiments, the one or more weather data sources 204 transmit predictions of weather conditions for a prediction horizon. The data collector unit 206 generates a data sample 112 including a set of features 110 for the power generation device 108, e.g., at least one of a solar irradiance feature, a cloud coverage feature, an ambient temperature feature, a humidity feature, a geographic location feature, a power generation device type feature, a data sample time feature, or a power output feature. In some embodiments, the data collector unit 206 stores each of the data samples 112 as a multidimensional vector.

A power output prediction engine 126 receives the data sample 112 and provides the data sample 112 as input to a machine learning model 128. As discussed in FIG. 2, the training of the machine learning model 128 is based on the training data set 122 that includes the non-outlier data samples 120 and excludes at least one of the outlier data samples 118. The power output prediction engine 126 receives the output of the machine learning model 128 and generates a predicted power output 130 of the power generation device 108. In some embodiments, the power output prediction engine 126 translates an output of the machine learning model 128 into the predicted power output 130, e.g., by scaling the output of the machine learning model 128 and/or adding an offset to the output of the machine learning model 128. In some embodiments, the training data set 122 includes non-outlier data samples 120 of power generation devices operating in an MPPG mode, and excludes at least one of the outlier data samples 118 of power generation devices 108 operating in a non-MPPG mode. The output of the machine learning model 128 represents the predicted power output 130 of the power generation device 108-2 if operating in an MPPG mode.

In some embodiments, the power output engine 126 initiates one or more actions based on the predicted power output 130 of the power generation device 108. In some embodiments, the power output engine 126 logs the predicted power output 130, e.g., including at least part of the data sample 112, the output of the machine learning model 128, an identifier of the power generation device 108, and/or a timestamp of the data sample 112. In some embodiments, the power output engine 126 operates one or both of a second power generation device 108 or a power load device, wherein the operating is based on the predicted power output of the first power generation device. For example, if the power output of the power generation device 108 is below a predicted power output 130 in an MPPG mode, the power output engine 126 can activate a second power generation device 108 to provide supplemental power and/or disable a power load to avoid exhausting the supplied power.

In some embodiments, the power output prediction engine 126 generates a predicted power output 130 of the power generation device 108 at a future point in time (e.g., a prediction of power output tomorrow based on a weather forecast received from the weather data source 204). Further, the power output prediction engine 126 can transmit the predicted power output 130 to a solar generation forecast module 302, which can use the predicted power output 130 in operations such as resource allocation and scheduling.

In some embodiments, the power output prediction engine 126 compares the predicted power output 130 of the power generation device 108 and a power output measurement of the power generation device 108. For example, the power output prediction engine 126 can perform the comparison to determine whether the power generation device 108 is operating in an MPPG mode. If the predicted power output 130 of the power generation device 108 matches the power output measurement of the power generation device 108, the power output prediction engine 126 can record an indication that the power generation device 108 is operating in an MPPG mode. If the predicted power output 130 of the power generation device 108 is above the power output measurement of the power generation device 108, the power output prediction engine 126 can record an indication that the power generation device 108 is operating in a non-MPPG mode. Further, the power output prediction engine 126 can notify an alerting system 304 to generate an alert regarding the non-MPPG mode of the power generation device 108, such as a request for diagnosis, maintenance, and/or replacement of power generation device 108. if the predicted power output 130 of several power generation devices 108 do not match the power output measurements of the power generation device 108, the power output prediction engine 126 can determine a possible occurrence of drift of the machine learning model 128, and can request an update of the training data set 122 and/or a retraining of the machine learning model 128.

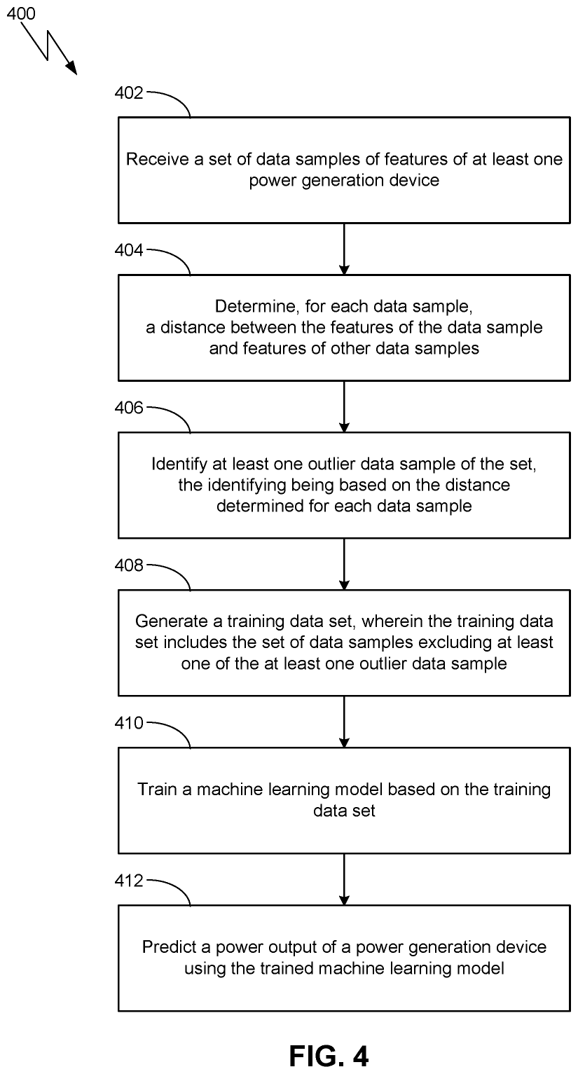

FIG. 4 is a flow diagram of method steps for predicting a power output of a power generation device by the machine learning model of FIGS. 1-3, according to one or more embodiments. At least some of the method steps could be performed, for example, by the training data set generator engine 116 of FIG. 1 or FIG. 2, the machine learning trainer 124 of FIG. 1 or FIG. 2, and/or the power output prediction engine 126 of FIG. 1 or FIG. 3. Although the method steps are described with reference to FIGS. 1-3, persons skilled in the art will understand that any system may be configured to implement the method steps, in any order, in other embodiments.

As shown, at step 402, a training data set generator engine receives a set of data samples of features of at least one power generation device. In some embodiments, the data samples include at least one of a solar irradiance feature, a cloud coverage feature, an ambient temperature feature, a humidity feature, a geographic location feature, a power generation device type feature, a data sample time feature, or a power output feature.

At step 404, a training data set generator engine determines, for at least some of the data samples, a distance between the features of the data sample and features of other data samples. In some embodiments, the training data set generator engine performs a K-nearest-neighbor determination between a data sample and K nearest other data samples within a feature space.

At step 406, a training data set generator engine identifies at least one outlier data sample of the set, the identifying being based on the distances determined for the data samples. In some embodiments, the training data set generator engine determines the outlier data samples based on a ranking of the distances of the data samples, such as a determination that the top 10% of the data samples with the largest distances are outlier data samples. In some embodiments, the training data set generator engine determines the outlier data samples based on a comparison of the distances with a distance threshold.

At step 408, a training data set generator engine generates a training data set, wherein the training data set includes the set of data samples excluding at least one of the at least one outlier data sample. In some embodiments, the training data set generator engine balances selects data samples that provide a balanced training data set.

At step 410, a training data set generator engine trains a machine learning model based on the training data set. In some embodiments, the machine learning trainer trains the machine learning model through a number of epochs until a loss function, determined as a difference between the power outputs of the data samples and the predicted power outputs output by the machine learning model, is below a loss function threshold.

At step 412, a power output prediction engine predicts a power output of a power generation device using the trained machine learning model. The power output prediction engine predicts the power output based on the features of the power generation device. In some embodiments, a power output prediction engine initiates further actions based on the predicted power output, such as updating a solar generation forecast, generating one or more alerts, or initiating a retraining of the machine learning model.

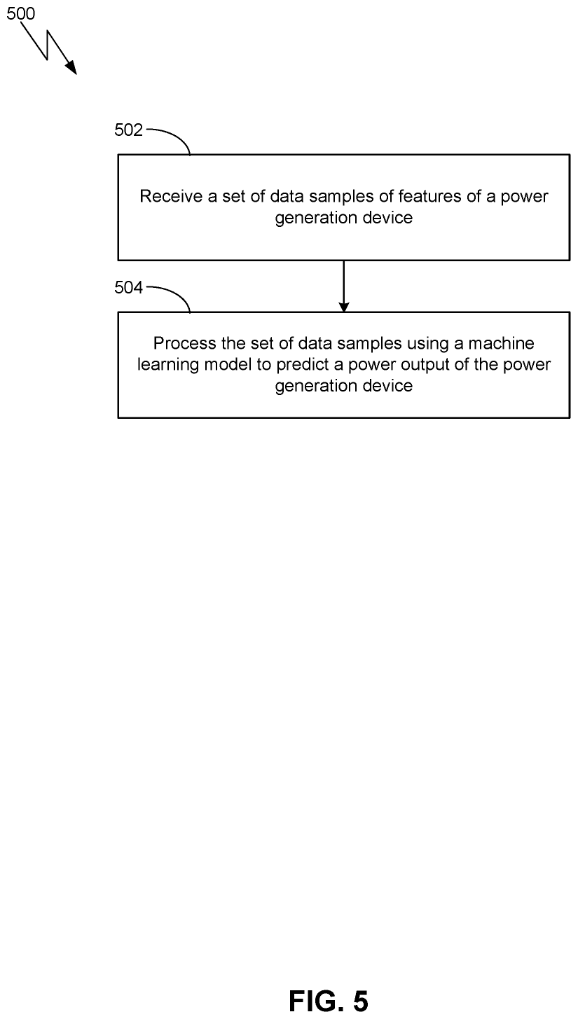

FIG. 5 is another flow diagram of method steps for predicting a power output of a power generation device by the machine learning model of FIGS. 1-3, according to one or more embodiments. At least some of the method steps could be performed, for example, by the training data set generator engine 116 of FIG. 1 or FIG. 2, the machine learning trainer 124 of FIG. 1 or FIG. 2, and/or the power output prediction engine 126 of FIG. 1 or FIG. 3. Although the method steps are described with reference to FIGS. 1-3, persons skilled in the art will understand that any system may be configured to implement the method steps, in any order, in other embodiments.

As shown, at step 502, a training data set generator engine receives a set of data samples of features of a power generation device. In some embodiments, the data samples include at least one of a solar irradiance feature, a cloud coverage feature, an ambient temperature feature, a humidity feature, a geographic location feature, a power generation device type feature, a data sample time feature, or a power output feature.

As shown, at step 504, a power output prediction engine processes the set of data samples using a machine learning model to predict a power output of the power generation device, wherein the machine learning model has been trained on a set of data samples excluding at least one outlier data sample, and wherein the at least one outlier data sample has been determined based on a distance between features of the outlier data sample and features of other data samples of the set of data samples. In some embodiments, the distances are determined according to a K-nearest-neighbor determination between the features of one data sample and the features of the other data samples of the data sample set.

In sum, training data sets for training machine learning models are disclosed in which outlier data samples are identified and excluded. An embodiment generates the training data set by receiving a set of data samples of features of at least one power generation device, such as solar irradiance, ambient temperature, or the like. The embodiment determines distances between the features of one data sample and those of the other samples. The embodiment identifies outlier data samples based on the distances determined for the data samples. The embodiment generates a training data set that includes the set of data samples excluding the identified outlier data samples. The resulting training data set more accurately reflects the maximum power output of a power generation device based on the features. Machine learning models trained using the resulting training data set can generate predictions with improved accuracy due to the exclusion of the outlier data samples from the training data set.

At least one technical advantage of the disclosed techniques is the improved accuracy of maximum possible power output predictions by machine learning models trained on the training data set. For example, based on a predicted power output and a measured power output of a power generation device, an alerting system can determine whether the power generation device is operating in a maximum potential power generation (MPPG) mode. Due to the improved accuracy, power output predictions can be relied upon with greater confidence for resource planning and scheduling. Further, machine learning models can be more rapidly and successfully trained using the training data set due to improved consistency of the included data samples. Thus, training machine learning models based on the training data set can be accomplished greater efficiently and reduced time and energy expenditure. Also, due to the improved speed and likelihood of success of training, the machine learning models can be retrained and deployed on an updated training data set more quickly, thus improving the adaptability of the machine learning models to new data. Also, the training data set can include a larger variety of data points that are collected from a wider variety of power generation devices and/or under a wider variety of circumstances. As result, machine learning models that are trained on the training data set have a wider range of robustness in terms of the combinations of features for which predictions can be accurately generated. Finally, excluding outliers from the training data set can avoid a problem in which a machine learning model trained with non-MPPG data points could underestimate the achievable power output of other power generation devices, resulting in the collection of additional non-MPPG data points that diminish future predictions. Identifying and excluding the non-MPPG data points from this vicious cycle can therefore improve the cycle of accurate predictions and the operation of power generation devices in an MPPG mode based on the predictions. These technical advantages provide one or more technological improvements over prior art approaches.

1. In some embodiments, a computer-implemented method comprises receiving a set of data samples of features of at least one power generation device; determining, for at least some of the data samples, a distance between the features of the data sample and features of other data samples; identifying at least one outlier data sample of the data sample set based on the distances determined for at least some of the set of data samples; and generating a training data set for a machine learning model, wherein the training data set includes the set of data samples excluding at least one of the at least one outlier data sample.

2. The computer-implemented method of clause 1, wherein the features of the data samples include at least one of a solar irradiance feature, a cloud coverage feature, an ambient temperature feature, a humidity feature, a geographic location feature, a power generation device type feature, a data sample time feature, and a power output feature.

3. The computer-implemented method of clauses 1 or 2, further comprising normalizing the features of at least some of the data samples.

4. The computer-implemented method of any of clauses 1-3, wherein the identifying is based on a K-nearest-neighbor determination between the features of a first data sample and the features of other data samples.

5. The computer-implemented method of any of clauses 1-4, wherein the identifying is based at least in part on applying a rule to each of at least one of the data samples of the set.

6. The computer-implemented method of any of clauses 1-5, wherein identifying the at least one outlier data sample includes ranking the data samples by the determined distances and identifying, as the outlier data samples, data samples within a top portion of the ranking.

7. The computer-implemented method of any of clauses 1-6, wherein the distance determined for each data sample is based on a Minkowski distance between the features of the data sample and the features of other data samples.

8. The computer-implemented method of any of clauses 1-7, wherein the distance determined for each data sample is based on an arithmetic median of the distance between the features of the data sample and the features of other data samples.

9. The computer-implemented method of any of clauses 1-8, wherein identifying the at least one outlier data sample includes identifying the data samples having a determined distance that is above a threshold distance.

10. The computer-implemented method of any of clauses 1-9, wherein identifying the at least one outlier data sample is based on a comparison of a power output feature of the data sample and a power output measurement during a maximum potential power generation mode of a power generation device associated with the data sample.

11. The computer-implemented method of any of clauses 1-10, further comprising selecting, from the features, a subset of features for training the machine learning model.

12. The computer-implemented method of any of clauses 1-11, further comprising training a machine learning model based on the training data set.

13. The computer-implemented method of clause 12, further comprising retraining the machine learning model based on an update of the training data set.

14. The computer-implemented method of clauses 12 or 13, further comprising updating at least one hyperparameter associated with the machine learning model during a retraining of the machine learning model.

15. The computer-implemented method of any of clauses 12-14, further comprising predicting a power output of a first power generation device, the predicting being based on an output of the machine learning model in response to features of the first power generation device.

16. The computer-implemented method of clause 15, further comprising initiating an action based on a difference between the power output predicted for the first power generation device and a power output measurement of the first power generation device.

17. The computer-implemented method of clauses 15 or 16, wherein the power output is predicted for the first power generation device during a maximum potential power generation mode of the first power generation device based on the features of the first power generation device.

18. The computer-implemented method of any of clauses 15-17, further comprising operating one or both of a second power generation device or a power load device, wherein the operating is based on a predicted power output of the first power generation device.

19. In some embodiments, a system comprises a memory that stores instructions, and a processor that is coupled to the memory and, when executing the instructions, is configured to receive a set of data samples of features of at least one power generation device, determine, for each data sample, a distance between the features of the data sample and features of other data samples, identify at least one outlier data sample of the data sample set, the identifying being based on the distance determined for each data sample, and generate a training data set for a machine learning model, wherein the training data set includes the set of data samples excluding at least one of the at least one outlier data sample.

20. The system of clause 19, wherein the identifying is based on a K-nearest-neighbor determination between the features of each data sample and the features of the other data samples.

21. The system of clauses 19 or 20, wherein the instructions are further configured to train a machine learning model based on the training data set.

22. The system of any of clauses 19-21, wherein the instructions are further configured to predict a power output of a first power generation device, the predicting being based on an output of the machine learning model in response to features of the first power generation device.

23. In some embodiments, one or more non-transitory computer-readable media store instructions that, when executed by one or more processors, cause the one or more processors to perform the steps of receiving a set of data samples of features of at least one power generation device; determining, for each data sample, a distance between the features of the data sample and features of other data samples; identifying at least one outlier data sample of the data sample set, the identifying being based on the distance determined for each data sample; and training a machine learning model to predict power output of power generation devices, the training being based on the set of data samples excluding at least one of the at least one outlier data sample.

24. The one or more non-transitory computer-readable media of clause 23, wherein the identifying is based on a K-nearest-neighbor determination between the features of each data sample and the features of the other data samples.

25. The one or more non-transitory computer-readable media of clauses 23 or 24, wherein the instructions further cause the one or more processors to train a machine learning model based on the training data set.

26. The one or more non-transitory computer-readable media of any of clauses 23-25, wherein the instructions further cause the one or more processors to predict a power output of a first power generation device, the predicting being based on an output of the machine learning model in response to features of the first power generation device.

27. In some embodiments, a computer-implemented method comprises receiving a set of data samples of features of a power generation device; and processing the set of data samples using a machine learning model to predict a power output of the power generation device, wherein the machine learning model has been trained on a set of data samples excluding at least one outlier data sample, and wherein the at least one outlier data sample has been determined based on a distance between features of the outlier data sample and features of other data samples of the set of data samples.

28. The computer-implemented method of clause 27, further comprising determining, based on the predicted power output and a measured power output of the power generation device, whether the power generation device is operating in a maximum potential power generation mode.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method, comprising:
receiving a set of data samples of features of at least one power generation device;
determining, for at least some of the data samples, a distance between the features of the data sample and features of other data samples;
identifying at least one outlier data sample of the data sample set based on the distances determined for at least some of the set of data samples; and
generating a training data set for a machine learning model, wherein the training data set includes the set of data samples excluding at least one of the at least one outlier data sample.

2. The computer-implemented method of claim 1, wherein the features of the data samples include at least one of a solar irradiance feature, a cloud coverage feature, an ambient temperature feature, a humidity feature, a geographic location feature, a power generation device type feature, a data sample time feature, and a power output feature.

3. The computer-implemented method of claim 1, further comprising normalizing the features of at least some of the data samples.

4. The computer-implemented method of claim 1, wherein the identifying is based on a K-nearest-neighbor determination between the features of a first data sample and the features of other data samples.

5. The computer-implemented method of claim 1, wherein the identifying is based at least in part on applying a rule to each of at least one of the data samples of the set.

6. The computer-implemented method of claim 1, wherein identifying the at least one outlier data sample includes ranking the data samples by the determined distances and identifying, as the outlier data samples, data samples within a top portion of the ranking.

7. The computer-implemented method of claim 1, wherein the distance determined for each data sample is based on a Minkowski distance between the features of the data sample and the features of other data samples.

8. The computer-implemented method of claim 1, wherein the distance determined for each data sample is based on an arithmetic median of the distance between the features of the data sample and the features of other data samples.

9. The computer-implemented method of claim 1, wherein identifying the at least one outlier data sample includes identifying the data samples having a determined distance that is above a threshold distance.

10. The computer-implemented method of claim 1, wherein identifying the at least one outlier data sample is based on a comparison of a power output feature of the data sample and a power output measurement during a maximum potential power generation mode of a power generation device associated with the data sample.

11. The computer-implemented method of claim 1, further comprising selecting, from the features, a subset of features for training the machine learning model.

12. The computer-implemented method of claim 1, further comprising training a machine learning model based on the training data set.

13. The computer-implemented method of claim 12, further comprising retraining the machine learning model based on an update of the training data set.

14. The computer-implemented method of claim 12, further comprising updating at least one hyperparameter associated with the machine learning model during a retraining of the machine learning model.

15. The computer-implemented method of claim 12, further comprising predicting a power output of a first power generation device, the predicting being based on an output of the machine learning model in response to features of the first power generation device.

16. The computer-implemented method of claim 15, further comprising initiating an action based on a difference between the power output predicted for the first power generation device and a power output measurement of the first power generation device.

17. The computer-implemented method of claim 15, wherein the power output is predicted for the first power generation device during a maximum potential power generation mode of the first power generation device based on the features of the first power generation device.

18. The computer-implemented method of claim 15, further comprising operating one or both of a second power generation device or a power load device, wherein the operating is based on a predicted power output of the first power generation device.

19. A system, comprising:
a memory that stores instructions, and
a processor that is coupled to the memory and, when executing the instructions, is configured to:
receive a set of data samples of features of at least one power generation device,
determine, for each data sample, a distance between the features of the data sample and features of other data samples,
identify at least one outlier data sample of the data sample set, the identifying being based on the distance determined for each data sample, and
generate a training data set for a machine learning model, wherein the training data set includes the set of data samples excluding at least one of the at least one outlier data sample.

20. The system of claim 19, wherein the identifying is based on a K-nearest-neighbor determination between the features of each data sample and the features of the other data samples.

21. The system of claim 19, wherein the instructions are further configured to train a machine learning model based on the training data set.

22. The system of claim 21, wherein the instructions are further configured to predict a power output of a first power generation device, the predicting being based on an output of the machine learning model in response to features of the first power generation device.

23. One or more non-transitory computer-readable media storing instructions that, when executed by one or more processors, cause the one or more processors to perform the steps of:
receiving a set of data samples of features of at least one power generation device;
determining, for each data sample, a distance between the features of the data sample and features of other data samples;
identifying at least one outlier data sample of the data sample set, the identifying being based on the distance determined for each data sample; and
training a machine learning model to predict power output of power generation devices, the training being based on the set of data samples excluding at least one of the at least one outlier data sample.

24. The one or more non-transitory computer-readable media of claim 23, wherein the identifying is based on a K-nearest-neighbor determination between the features of each data sample and the features of the other data samples.

25. The one or more non-transitory computer-readable media of claim 23, wherein the instructions further cause the one or more processors to train a machine learning model based on the training data set.

26. The one or more non-transitory computer-readable media of claim 25, wherein the instructions further cause the one or more processors to predict a power output of a first power generation device, the predicting being based on an output of the machine learning model in response to features of the first power generation device.

27. A computer-implemented method, comprising:
receiving a set of data samples of features of a power generation device; and
processing the set of data samples using a machine learning model to predict a power output of the power generation device,
wherein the machine learning model has been trained on a set of data samples excluding at least one outlier data sample, and wherein the at least one outlier data sample has been determined based on a distance between features of the outlier data sample and features of other data samples of the set of data samples.

28. The computer-implemented method of claim 27, further comprising determining, based on the predicted power output and a measured power output of the power generation device, whether the power generation device is operating in a maximum potential power generation mode.
